(19) United States
(12) Patent Application Publication
(10) Pub. No.: US 2018/0249193 A1
(43) Pub. Date: Aug. 30, 2018

(54) METHOD AND APPARATUS FOR GENERATING VIDEO DATA USING TEXTUAL DATA

(71) Applicant: Alibaba Group Holding Limited, Grand Cayman (KY)

(72) Inventors: Yanan ZHANG, Hangzhou (CN); Zhou YE, Hangzhou (CN); Yu WANG, Hangzhou (CN); Yang YANG, Hangzhou (CN); Fei SU, Hangzhou (CN)

(21) Appl. No.: 15/897,387

(22) Filed: Feb. 15, 2018

(30) Foreign Application Priority Data
Feb. 28, 2017 (CN) 201710119022.3

(51) Int. Cl. H04N 21/25; H04N 21/235; H04N 21/234; H04N 21/266; H04N 21/2668

(52) U.S. Cl. CPC H04N 21/251; H04N 21/2353; H04N 21/23418; G06F 17/2785; H04N 21/2668; H04N 21/23424; H04N 21/26603

(57) ABSTRACT

Embodiments of the disclosure provide a method and apparatus for recommending video data. In one embodiment, a method is disclosed comprising: retrieving, by a server device, text data and video data; generating, by the server device, a relationship graph, the relationship graph representing a semantic mapping of the text data; generating, by the server device, candidate video segment data based on the video data, the candidate video segment data comprising semantic tag data; acquiring, by the server device, target video data according to the relationship graph and the candidate video segment data; and transmitting, by the server device, the target video data to a client device. The embodiments of the disclosure can screen and select personalized target video data from big video data according to a relationship graph showing a semantic mapping without human assistance during the whole process, greatly improving the video content browsing experience of users and increasing the conversion rate.

### CROSS-REFERENCE TO RELATED APPLICATIONS

This application claims the benefit of priority of Chinese Application No. 201710119022.3, titled “METHOD, APPARATUS AND SERVER FOR VIDEO DATA RECOMMENDATION,” filed on Feb. 28, 2017, which is hereby incorporated by reference in its entirety.

### BACKGROUND

### Technical Field

The disclosed embodiments relate to the field of data processing technologies, and in particular, to methods and apparatuses for generating video data using textual data.

### Description of the Related Art

Shopping guides, marketing and community-based operations that are based on video data have become the focus in e-commerce website operations. This type of marketing has strong accessibility and helps users to learn the characteristics and features of target products in greater details with high interactivity and user-friendliness. Therefore, compared with conventional operation methods, video-based marketing improves the click-through rate from users as well as conversion rates.

However, the technical complexities of managing and organizing big video data efficiently and effectively (as well as increasing click-through rates and capturing users' core interests) have significantly limited the development of big video data systems. Existing systems require manual capture of parts of video data that may be of interest to users from a large corpus of shopping guide/scene video content. Short videos presented to end users are then created by manually integrating the parts of video data. This process wastes a large number of valuable operational resources (both human and processing power), and the resulting videos fail to provide personalized content for each end user. That is, all end users see the same short video (without considering the age, consumption levels, personal points of interest, preference information, etc. of the end users).

Thus, none of the existing technologies can automatically generate corresponding short videos for a video shopping guide. Instead, the existing methods require numerous operators for integration and are therefore labor intensive. Moreover, the utilization rate of big video data is low, and videos are often limited to the video data with which the operators are familiar. However, with the need for big data in e-commerce, the manual integration of these videos cannot produce a personalization effect, nor can these videos meet the requirements of product promotion and overall merchandise volume increases.

### SUMMARY

Given aforementioned deficiencies, the disclosed embodiments provide methods for recommending video data, apparatuses for recommending video data, and servers for solving the above deficiencies.

In one embodiment, a method is disclosed comprising: retrieving, by a server device, text data and video data; generating, by the server device, a relationship graph, the relationship graph representing a semantic mapping of the text data; generating, by the server device, candidate video segment data based on the video data, the candidate video segment data comprising semantic tag data; acquiring, by the server device, target video data according to the relationship graph and the candidate video segment data; and transmitting, by the server device, the target video data to a client device.

In another embodiment, an apparatus is disclosed comprising: a processor; and a storage medium for tangibly storing thereon program logic for execution by the processor, the stored program logic comprising: logic, executed by the processor, for retrieving text data and video data, logic, executed by the processor, for generating a relationship graph, the relationship graph representing a semantic mapping of the text data, logic, executed by the processor, for generating candidate video segment data based on the video data, the candidate video segment data comprising semantic tag data, logic, executed by the processor, for acquiring target video data according to the relationship graph and the candidate video segment data, and logic, executed by the processor, for transmitting the target video data to a client device.

The disclosed embodiments provide the following technical advantages.

In the disclosed embodiments, input data including text data and video data is acquired; a relationship graph showing a semantic mapping is generated according to the text data, and candidate video segment data is generated according to the video data; finally, target video data to be recommended to users is acquired according to the relationship graph showing the semantic mapping and the candidate video segment data. The disclosed embodiments can screen and select personalized target video data from big video data according to a relationship graph representing a semantic mapping without human assistance during the whole process. The disclosed embodiments greatly improve the video content browsing experience of users and increase conversion rates.

### BRIEF DESCRIPTION OF THE DRAWINGS

FIG. 1 is a flow diagram illustrating a method for recommending video data according to some disclosed embodiments.

FIG. 2 is a flow diagram illustrating a method for recommending video data according to some disclosed embodiments.

FIG. 3 is a flow diagram illustrating a method for recommending video data according to some disclosed embodiments.

FIG. 4 is a flow diagram illustrating a method for recommending video data according to some disclosed embodiments.

FIG. 5 is a block diagram of an apparatus for recommending video data according to some disclosed embodiments.

FIG. 6 is a block diagram of an apparatus for identifying video data according to some disclosed embodiments.

FIG. 7 is a block diagram of a server according to some disclosed embodiments.

### DETAILED DESCRIPTION

To make the objects, features, and advantages of the disclosure more obvious and easy to understand, the disclosure is further described below in detail in conjunction with the accompanying figures and the specific embodiments.

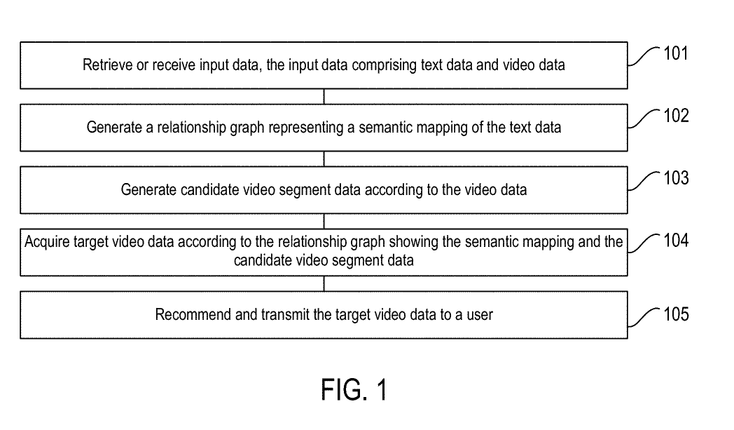

FIG. 1 is a flow diagram illustrating a method for recommending video data according to some disclosed embodiments. The method may include the following steps.

Step 101: Retrieve or receive input data, the input data comprising text data and video data.

In one embodiment the text data may include the official document for a shopping guide text or other scripts, and the video data may include big shopping guide video data. As used herein big video data (also referred to as big shopping guide video data) refers to big data in the form of video data. For example, big video data may include user generated video data uploaded to an e-commerce website.

In one embodiment of the disclosure, step 101 may include the following sub-steps.

Sub-step S11: Retrieve or receive raw data, the raw data including speech data.

Sub-step S12: Convert the speech data into text data.

In one embodiment, when speech data is detected in the raw data (e.g., in sub-step S11), the speech data may be converted into text data first for subsequent processing (in sub-step S12).

Step 102: Generate a relationship graph representing a semantic mapping of the text data.

In one embodiment of the disclosure, a relationship graph showing a semantic mapping may be generated according to texts such as existing shopping guide texts or promotional texts. The relationship graph showing the semantic mapping may record associations among semantic entities.

In one embodiment, step 102 may include the following sub-steps.

Sub-step S21: Extract semantic entities from the text data.

Sub-step S22: Extract associations among the semantic entities from the text data.

Sub-step S23: Save the associations among the semantic entities as the relationship graph showing the semantic mapping.

In one embodiment, semantic entities (also referred to as linguistic entities) in the text data may be extracted. Associations among the semantic entities are analyzed to extract the associations and use the associations as edges for the relationship graph showing the semantic mapping.

There may be a plurality of approaches for extracting semantic entities from text data and for creating associations among the semantic entities. Two main types are described herein: rule-based methods and statistical model-based methods.

Rule-based methods use keywords (such as express, belong to, is, and depend on) identified in a large amount of text data and perform extraction on to-be-extracted text data according to the given keywords.

Statistical model-based methods train a machine learning model with a large number of annotated texts and then semantic entities and associations among the semantic entities are extracted from a to-be-extracted sample. When this embodiment is implemented, a statistical model-based method may be used to extract semantic entities and associations among the linguistic entities.

Certainly, in one embodiment, semantic entities may also be extracted with other implementations other than a rule-based method and a statistical model-based method, which is not to be limited in the disclosed embodiments.

As an example, a predicate may be used as an association between semantic entities, but because associations expressed by a predicate are flexible and varied, the predicate may be accurately identified and the meaning of the predicate may be tagged according to the context in which a semantic entity appears. That is, disambiguation processing of the predicate may be performed to improve the processing accuracy of the application.

After the extraction of the semantic entities and the associations among the semantic entities is completed, one embodiment of the disclosure may construct the relationship graph showing the semantic mapping by treating the involved semantic entities as points or nodes and the associations among the semantic entities as edges. If a query is a multi-relational query, the relationship graph showing the semantic mapping will contain multiple points and multiple edges. Certainly, manners other than a graph may also be used to record the semantic entities and the associations among the semantic entities, which is not limited in the disclosure.

In one embodiment of the disclosure, sub-step S21 may include the following sub-steps.

Sub-step S211: Perform filtering processing on preset feature texts in the text data.

Sub-step S212: Extract the semantic entities from text data on which the filtering processing has been performed.

For text data including the speech data converted from speech data, some necessary cleaning may be performed in advance before the semantic entities are extracted so that the preset feature texts are removed. Specifically, preset feature texts such as modal particles, stop words, and auxiliary words in the text data may be filtered out to acquire more normalized text data, and then the subsequent semantic entity extraction processing may be performed.

Step 103: Generate candidate video segment data according to the video data.

In one embodiment of the disclosure, multiple pieces of candidate video segment data may be generated according to video frames of big video shopping guide data, wherein the candidate video segment data comprise semantic tags. In one embodiment of the disclosure, step 103 may include the following sub-steps.

Sub-step S31: Divide the video data into video frames, wherein the video frames comprise subtitle text data.

Sub-step S32: Extract semantic tags from the subtitle text data.

Sub-step S33: Add the semantic tags to the corresponding video frames.

Sub-step S34: Identify video frames having the same semantic tag as a candidate video frame set.

Sub-step S35: Generate the candidate video segment data according to the candidate video frame set.

In one embodiment, the video data may be divided into video frames, and then semantic analysis and modeling may be performed on the video frames, including analyzing subtitle text data of the video frames, extracting view text data of the video frames, performing division to acquire the video frames, extracting objects, and the like.

The subtitle text data refers to dubbing or subtitles in the text data of the video data corresponding to the video frames. The view text data is text data generated according to picture meanings extracted after a picture analysis routine is performed on the video frame.

For the subtitle text data of the video frames, the clustering of the video frames and the extraction of objects of the video frames may be performed in subtitle text data units according to scenes and pauses of the subtitle text data. The minimum clustering result of the video frames is then marked with semantic tags. Semantic tags are summary statements for scenes clustered out of a set of video frames. For example, the semantic tags may include driving, boating, running, and enjoying a big meal, and they may even include cooking, mopping, washing clothes, and other scenes.

In general, lines are divided and scenes are classified according to the semantic description and semantic pause words of the subtitle text data. For example, in the following description “I drove to the forest park to relax today, went boating there and then ran around the lake, and finally ate a big meal at a restaurant”, a clustering result of video frames corresponding to subtitle text data may give rise to four semantic tags: driving, boating, running, and eating a big meal. Then, video frames are clustered according to the video frames corresponding to the semantic tags. That is, video frames having the same semantic tag may be used as a candidate video frame set. In the above scenario, after the video frames are marked as the scenes corresponding to the four semantic tags, a series of video frames attached with each semantic tag are segmented to extract video frame objects.

For example, in the boating scene, object feature data of a series of video frames is extracted. For example, the shape of the boat, whether the boat comes with canopy, whether the boat has a paddle, and whether the background is a lake or a river may be extracted. This data helps to provide a better understanding of the meanings of the pictures and the clustering result may then be verified for its accuracy and completeness.

In one embodiment of the disclosure, sub-step S32 may include the following sub-steps.

Sub-step S321: Extract candidates of semantic tags from the subtitle text data according to a preset document theme generation model LDA.

Sub-step S322: Calculate term frequency-inverse document frequency values for the candidates of semantic tags.

Sub-step S323: Use the top M sorted candidates of semantic tags as the semantic tags, wherein M is a positive integer.

LDA (Latent Dirichlet Allocation) analysis is performed on the subtitle text data of the video frames to extract the semantic entities. The subtitle text data forms a corpus of a large number of raw texts, and then LDA modeling and segmentation is performed to output a set of candidates of semantic tags. Then, term frequency-inverse document frequency (TF-IDF) values of these candidates of semantic tags are calculated. The TF-IDF values are ranked according to the sizes of the values, and some selected semantic tags with the largest values are output. For example, the top M sorted candidates of semantic tags may be outputted as the final semantic tags.

In one embodiment of the disclosure, the video frames may have view text data, and the sub-step S34 may further include the following sub-steps.

Step S341: Categorize the semantic tags into new semantic tags with the view text data.

Step S342: Add the new semantic tags to corresponding video frames as semantic tags.

Step S343: Use video frames having the same new semantic tag as a candidate video frame set.

In one embodiment, the video frames with the existing semantic tags may be hierarchically re-clustered according to the view text data and image object identification of the video frames and the semantic tags of the video frames may be merged using semantic maximization.

Specifically, by means of the view text data and the image object recognition of the video frames, objects in the video frames, their morphological features, background objects, and their morphological features are identified. For example, both the boating and running scenes actually take place in the forest park; and boating and running consist of a series of consecutive video frames according to the analysis on the content of the boating and running video frames. Therefore, based on hierarchically re-clustering using semantic maximization, the semantic tags of boating and running are merged to generate a new semantic tag of recreation in the forest park. The new semantic tag of recreation in the forest park covers two consecutive activity scenes in the forest park, boating and running; and the two scenes are consecutive and coherent.

In one embodiment, some adjacent video frames may belong to different semantic tags. If the video frames are integrated into candidate video segment data based on the semantic tags, the candidate video segment data may not be smooth enough. Therefore, in one embodiment of the disclosure, a hidden Markov model (HMM) is constructed according to the smallest unit segmented segments of a continuous frame to find an optimal segment path. Then, the optimal segment path is used to perform smoothing and de-noising processing on the divided video frame clustering result.

The optimal segment path refers to the most reasonable disconnection point between a video frame and another video frame. For example, a video frame might belong to a semantic tag A and its next frame might belong to a semantic tag B. The HMM will need to be constructed according to object content features extracted from a video frame, object content features extracted from the previous frame of the frame, and semantic tag features. Then, probabilities that the video frame belongs to the tag A and the tag B are outputted respectively; and finally a maximum probability to determine whether the frame belongs to the semantic tag A or the semantic tag B is selected.

Finally, based on an HMM result of the optimal segment path, semantic tag assignments of some boundary frames of the two semantic tags are outputted. By searching for the optimal segment path, some refinement smoothing and de-noising processing is performed on the boundary video frames again.

Step 104: Acquire target video data according to the relationship graph showing the semantic mapping and the candidate video segment data.

In one embodiment of the disclosure, step 104 may include the following sub-steps.

Sub-step S41: Determine current promotion intention data, wherein the promotion intention data comprises intention keywords.

Sub-step S42: Locate semantic entities corresponding to the intention keywords in the relationship graph showing the semantic mapping.

Sub-step S43: Determine corresponding semantic tags based on the semantic entities.

Sub-step S44: Screen and select corresponding target candidate video segment data from the candidate video segment data based on the semantic tags.

Sub-step S45: Integrate the target candidate video segment data into the target video data.

One embodiment of the disclosure may integrate the target video data based on the technological framework of the relationship graph showing the semantic mapping and the candidate video segment data acquired in the previous steps.

Specifically, by analyzing the official document or a promotion intent in the text, an appropriate video segment is extracted from big shopping guide videos. First, keywords showing the intention are acquired via the analysis performed on the current promotion intention data. Then, corresponding semantic entities are found in the relationship graph showing the semantic mapping based on the keywords showing the intention; and then corresponding semantic tags are found based on the semantic entities. Finally, target candidate video segment data are found based on the semantic tags and are integrated to form a desired target video data.

In one embodiment of the disclosure, sub-step S45 may further include the following sub-steps.

Sub-step S451: Sort the target candidate video segment data according to a preset model.

Sub-step S452: Integrating the target video data based on the sorted target candidate video segment data.

To better meet user requirements, in one embodiment, the target candidate video segment data are further sorted based on a preset model first, so that a video segment meeting a user's needs can be displayed to the user earlier.

First, a series of semantic tags are constructed according to semantic information of video frames. For example, for the following scenario: “I drive to a swimming pool to swim, and then go to a street nearby to buy a mobile phone,” the video segment thereof can be decomposed into four semantic tags: driving, swimming, shopping on a street, and buying a mobile phone.

Then, candidate video segment data tagged with the semantic tags in a video library is found according to the semantic tags. The candidate video segments are sorted according to a preset e-commerce store and product model and a user personalized model. Preferably, video frames containing a popular product or based on user personalized information are selected.

Finally, a series of short video segments screened and selected according to the semantic tags are integrated to form an integrated short video, i.e., the target video data of the disclosure.

In one embodiment, after the step of integrating the target candidate video segment data into the target video data, the method may further include the following sub-steps: performing smoothing and de-noising processing on the target video data, wherein the smoothing and de-noising processing comprises adding a preset warm-up video frame and/or discarding a specified video frame.

The integrated video is smoothed and de-noised according to an expert rule to acquire a final short video for delivery; and the short video is delivered in a personalized manner according to a specific profile of a certain population.

The integrated video is spliced from several video segments. During a splicing process, there may be a problem of video cohesion. Therefore, corresponding smoothing filtering needs to be performed based on some expert rules. These rules may specifically include:

1. Video scene switching should not be too fast. For example, some warm-up videos may be added in a scene switching process.

2. There should be some transition during video tone and style changing. In this process, video segments that are out of place at the video joints may be discarded.

Certainly, the foregoing rule for processing the video is merely an example. When one embodiment of the disclosure is implemented, the video frames may be processed in other manners or rules so that video joints are smoother, which is not limited in the disclosure.

Step 105: Recommend and transmit the target video data to a user.

In one embodiment, after the target video data is acquired, the video data may be delivered (e.g., transmitted) to a user. The recommending the target video data to the user may be playing the target video data on a user interface, or may be pushing the target video data to the user. A specific manner of recommending the target video data is not limited in the disclosure.

In the embodiments of the disclosure, input data including text data and video data is acquired; a relationship graph showing a semantic mapping is generated according to the text data, and candidate video segment data is generated according to the video data; and finally target video data to be recommended to users is acquired according to the relationship graph showing the semantic mapping and the candidate video segment data. The embodiments of the disclosure can screen and select personalized target video data from big video data according to a relationship graph showing a semantic mapping without human assistance during the whole process, greatly improving the video content browsing experience of users and increasing the conversion rate.

To enable those skilled in the art to better understand one embodiment of the disclosure, the following embodiment of the disclosure is provided with a specific example.

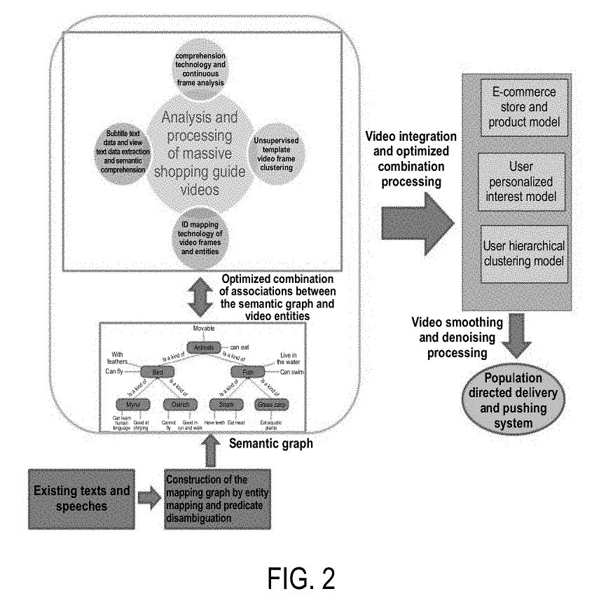

FIG. 2 is a flow diagram illustrating a method for recommending video data according to some disclosed embodiments. The method may specifically include the following processes.

### I. Preprocessing of Text Data and Speech Data

Perform speech/text de-noising preprocessing (input): Convert speech data into text data. Some necessary cleaning needs to be performed on the text data, such as removing modal particles, common words, and auxiliary words.

### II. Entity Mapping

Extract entities in a language and their relationships (input): Extract linguistic entities in a text; analyze relationships among the entities; and extract the relationships to form edges of a semantic relationship mapping graph.

### III. Predicate Disambiguation

Predicate identification and synonym annotation (input): Accurately identify a predicate and annotate the meaning of the predicate according to the context where a semantic entity appears.

### IV. Semantic Relationship Mapping Graph Construction

Construct a semantic graph with the semantic entities and the predicates and their relationships (input): Treat the involved entities as points and treat the relationships among the entities as edges to construct a semantic relationship mapping graph. In the case of a multi-relational query, the semantic relationship mapping graph will contain multiple points and multiple edges.

### V. Image Comprehension Technology and Continuous Frame Analysis

Analyze the meaning represented by video data and perform modeling analysis on a continuous frame (input): Perform sequence analysis on an image, and perform modeling analysis on the analyzed image, including the following steps:

Step 1: Divide the video data into the smallest video frames (A, B, C, D, and the like), and then perform semantic analysis and modeling on the video frames, including analyzing subtitle text data of the video frames, extracting view text data of the video frames, performing division to acquire the video frames, extracting objects, and the like. For the subtitle text data of the video frames, the clustering of the video frames and the division of objects of the video frames are performed in subtitle text units according to scenes and pauses of the subtitle text data; the minimum clustering result of the video frames are then marked with semantic tags.

Step 2: Hierarchically re-cluster the video frames with the existing semantic tags according to the view text data and image object identification of the video frames; and merge the semantic tags of the video frames according to the principle of semantic maximization.

Step 3: Finally, construct a hidden Markov model according to the smallest unit segmented segments of a continuous frame to find an optimal segment path; and then the optimal segment path is used to perform smoothing and de-noising processing on the divided video frame clustering result.

Vi. Subtitle Text Data and View Text Data Extraction and Semantic Comprehension

Perform semantic graph modeling on the video frame subtitles and view text extraction (input): Perform semantic entity modeling on the subtitles of the video frames, and perform LDA analysis to extract semantic entity keywords; and also perform segmentation and extraction on texts in views, including the following steps.

Step 1: Perform semantic analysis on the subtitle text data of the image; then perform LDA modeling based on the existing corpus. Then perform LDA extraction on the image lines and perform TF-IDF calculation according to the semantic keywords to extract the semantic tags of the video frames.

Step 2: Analyze the semantic meanings of the video frames, and merge the video frames.

### VII. ID Mapping Technology of the Video Frames and the Entities

Perform de-noising on the semantic tags and the video entity frames, and perform filtering processing (input): Perform further processing on the video frame clustering result and the semantic tags of the video frames; perform de-noising, and perform verification according to rules so that the video frames and the semantic tags correspond to each other in a better way.

### VIII. Video Integration and Optimized Combination Processing

Use a preset e-commerce store and product model, a user personalized model, a user hierarchical clustering model, and other models to integrate the video data (input), mainly including the following steps.

Step 1: The e-commerce store and product model are used to screen video frames. For example, when a shot of women's clothing is needed, a popular SKU is acquired via screening according to a women's clothing product model; or a potential category of interest of a user is acquired via screening according to a user personalized model; the purpose is to provide personalized services.

Step 2: The user personalized model is mainly used to sort and screen the video frames. For example, some female users might have the need for shots with romantic scenes, whereas more shots with more masculine scenes might be needed for men. These can be done in a personalized manner via integrating the videos according to profiles of users.

Step 3: The user hierarchical clustering model is used to cluster users hierarchically and further divide the users into larger category clusters, so that it is convenient to perform particular processing for users in a certain category.

### IX. Population Directed Delivery and Pushing System

The integrated video is smoothed and de-noised according to expert rules to acquire a final short video for delivery; and the short video is delivered in a personalized manner according to specific configuration data of a certain population.

In conclusion, a specific implementation order of the disclosure may include the following operations.

Input: Existing texts and speeches (including official documents, scripts, and the like).

Step 1: Text and speech preprocessing, entity mapping/predicate disambiguation/construction of a semantic mapping graph.

Step 2: Analysis and processing of big shopping guide videos, image comprehension and continuous frame analysis modeling.

Step 3: Subtitle text data and view text data extraction and semantic comprehension, LDA modeling for extracting key semantic words as semantic tags.

Step 4: Association of the semantic tags with video frames and reprocessing according to hierarchical clustering.

Step 5: ID mapping technology of the video frames and semantic entities.

Step 6: Integration of a short video according to an e-commerce store and product model, a user personalized model, and a user hierarchical clustering model, and de-noising and smoothing processing according to rules.

Output: Personalized videos service for different population; delivery of the tailor-made videos in a personalized manner in the personalized delivery and pushing system.

(1) Based on the above description, it can be seen that the disclosure enables a new automated and personalized video content generation and pushing delivery system, which achieves the following effects: based on the current official document and promotion intention, an appropriate video segment is extracted from big shopping guide videos by analyzing the official document or the promotion intention in the text; and semantic tags and big frame segments are associated via tagging. In this process, personalized recommendation, image and video analysis technologies, and a popular product selection technology are utilized to automatically integrate video guide videos corresponding to end users at different levels with different tastes, thereby improving user service experience, increasing conversion rate, and boosting gross monthly revenue. The system can greatly improve operation efficiency, energize live broadcast operations, and satisfy users' “personalized content” needs; and on this basis, commercial values are then maximized.

(2) Based on (1), a semantic analysis and mapping graph model is designed for constructing a semantic graph by treating involved linguistic entities as points and relationships among the entities as edges. In the case of a multi-relational query, the semantic relationship mapping graph will contain multiple points and multiple edges. Finally, a short video is integrated based on the semantic relationship mapping graph.

(3) Based on (1), an image comprehension and continuous frame analysis model is designed for performing sequence analysis on an image and performing frame modeling processing on the analyzed image; and finally, a continuous video frame is divided into individual video frames that are semantically independent from one another.

(4) Based on (1), a step of extracting subtitle text data and view text data of video frames and then transforming the subtitle text data and the view text data into a semantic graph is designed.

(5) Based on (1), a video integration and optimization processing model is designed for integrating the video semantic frames with an e-commerce store and product model, a user personalized model, and a user hierarchical clustering model; and finally performing de-noising and smoothing and the target video is inputted to a delivery system and is outputted according to population categories.

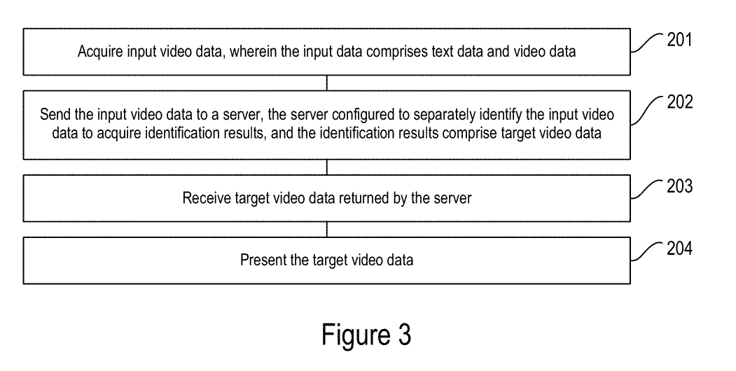

FIG. 3 is a flow diagram illustrating a method for recommending video data according to some disclosed embodiments. The method may include the following steps.

Step 201: Acquire input video data, wherein the input data comprises text data and video data.

Step 202: Send the input video data to a server, the server configured to separately identify the input video data to acquire identification results, and the identification results comprise target video data.

In one embodiment of the disclosure, a user inputs the input data through an interactive interface of a client. Specifically, the interactive interface may include one or more video input boxes, which may be arranged according to channels (e.g., a domestic channel and a foreign channel) or types of video data (e.g., an advertising video or a public service video). After completing the input, the user can click a submit button on the interactive interface to send the input video data to the server.

Step 203: Receive target video data returned by the server.

After receiving the video data transmitted by the client, the server identifies the video data to acquire an identification result. In the identification process, candidate video segment data may be acquired; and further, the target video data may also be acquired according to the candidate video segment data.

In one embodiment of the disclosure, step 203 may include the following sub-steps.

Sub-step S51: Send a promotion request to the server.

Sub-step S52: Receive the target video data screened and selected by the server from the candidate video segment data for the promotion request.

In practice, different promotion documents need to be planned according to factors such as user groups or promotion time. In one embodiment of the disclosure, a promotion request may be generated based on a promotion document and the request is sent to the server so that the server can screen and select target video data in line with the promotion document from the candidate video segment data.

Step 204: Present the target video data.

After acquiring the target video data, the server may feed the target video data back to the client and the client may present the target video data on the interactive interface. Further, after the target video data appears on the interactive interface, the user can click on it to play the target video data.

Because the embodiment illustrated in FIG. 3 is similar to the previously disclosed embodiments for recommending video data, reference may be made to the other descriptions and details are not repeated herein.

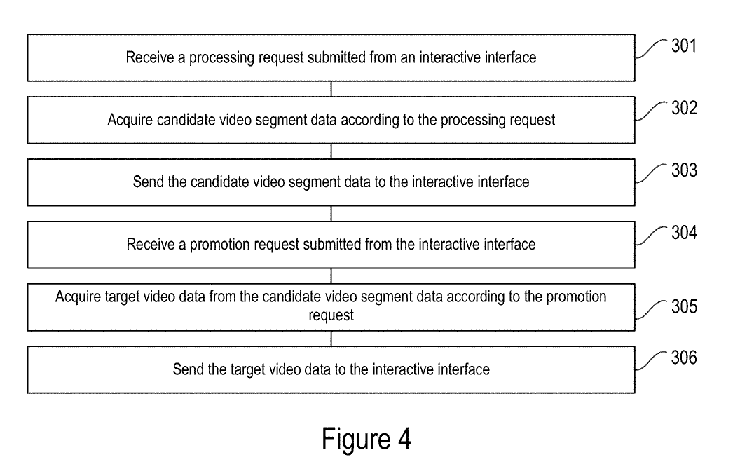

FIG. 4 is a flow diagram illustrating a method for recommending video data according to some disclosed embodiments. The method may include the following steps.

Step 301: Receive a processing request submitted from an interactive interface.

Step 302: Acquire candidate video segment data according to the processing request.

Step 303: Send the candidate video segment data to the interactive interface.

In one embodiment, after receiving a processing request submitted from an interactive interface of a client, a server processes input video data according to the processing request to acquire candidate video segment data, wherein the candidate video segment data are multiple pieces of video data having a large data volume. In this case, the candidate video segment data may be fed back to the interactive interface of the client first; and the user receives the candidate video segment data fed back by the server on the interactive interface.

In one embodiment of the disclosure, step 302 may include the following sub-steps.

Sub-step S61: Acquire input data, wherein the input data comprises text data and video data.

Sub-step S62: Generate a relationship graph showing a semantic mapping according to the text data.

Sub-step S63: Generate candidate video segment data according to the video data.

Specifically, for the input data submitted from the interactive interface, a relationship graph showing a semantic mapping is generated according to the text data in the input data, and the candidate video segment data is generated according to the video data in the input data. The relationship graph showing the semantic mapping includes semantic entities and associations among the semantic entities that are extracted from the text data.

The video data has subtitle text data. In one embodiment, the video data are divided to acquire video frames, and semantic tags are extracted from the subtitle text data and are added to corresponding video frames. Finally, video frames having the same semantic tag are combined so as to obtain the candidate video segment data.

The semantic tags are extracted from the subtitle text data.

Step 304: Receive a promotion request submitted from the interactive interface.

Step 305: Acquire target video data from the candidate video segment data according to the promotion request.

In one embodiment of the disclosure, step 305 may include the following sub-steps.

Sub-step S71: Extract intention keywords from the promotion request.

Sub-step S72: Locate semantic entities corresponding to the intention keywords in the relationship graph showing the semantic mapping.

Sub-step S73: Determine corresponding semantic tags based on the semantic entities.

Sub-step S74: Screen and select corresponding target candidate video segment data from the candidate video segment data based on the semantic tags.

Sub-step S75: Integrate the target candidate video segment data into the target video data.

In one embodiment, the method can further acquire video data more suitable for an actual requirement by screening from the candidate video segment data according to the requirement. Specifically, keywords may be inputted on the interactive interface of the client according to the current promotion intention and then a promotion request is generated and sent to the server. The server will find semantic entities corresponding to the intention keywords in the relationship graph showing the semantic mapping according to the intention keywords in the promotion request; determine corresponding semantic tags based on the semantic entities, and finally screen and select the target video data from the candidate video segment data with the semantic tags.

Step 306: Send the target video data to the interactive interface.

After the target video data is selected from the candidate video segment data, the target video data is sent to the interactive interface of the client for presentation.

It should be noted that in order to briefly describe each foregoing method embodiment, all the method embodiments are expressed as a combination of a series of actions but those skilled in the art should know that the disclosure is not limited by the sequence of the described actions. Certain steps can be applied with different sequences or can be carried out at the same time according to the disclosure. Second, those skilled in the art should also know that all the embodiments described in the description belong to exemplary embodiments and related actions are not necessarily needed for the embodiments of the disclosure.

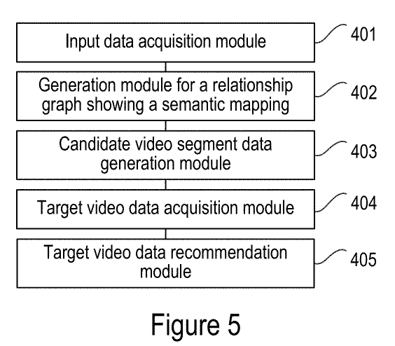

FIG. 5 is a block diagram of an apparatus for recommending video data according to some disclosed embodiments. The apparatus may include the following modules.

An input data acquisition module 401 is configured to acquire input data, wherein the input data comprises text data and video data.

A generation module for a relationship graph showing a semantic mapping 402 is configured to generate a relationship graph showing a semantic mapping according to the text data.

A candidate of video segment data generation module 403 is configured to generate candidate video segment data according to the video data.

A target video data acquisition module 404 is configured to acquire target video data according to the relationship graph showing the semantic mapping and the candidate video segment data.

A target video data recommendation module 405 is configured to recommend the target video data to a user.

In one embodiment, the input data acquisition module 401 may include the following modules.

A raw data acquiring submodule is configured to acquire raw data, the raw data includes speech data.

A speech data conversion submodule is configured to convert the speech data into text data.

In one embodiment, the generation module for a relationship graph showing a semantic mapping 402 may include the following modules.

A semantic entity extraction submodule is configured to extract semantic entities from the text data.

An association determining submodule is configured to extract associations among the semantic entities from the text data.

A data saving submodule is configured to save the associations among the semantic entities as the relationship graph showing the semantic mapping.

In one embodiment, the semantic entity extraction submodule may include the following modules.

A filtering processing unit is configured to perform filtering processing on preset feature texts in the text data.

A semantic entity extraction unit is configured to extract the semantic entities from text data on which the filtering processing has been performed.

In one embodiment, the candidate of video segment data generation module 403 may include the following modules.

A video frame dividing submodule is configured to divide the video data into video frames, wherein the video frames have subtitle text data.

A semantic tag extraction submodule is configured to extract semantic tags from the subtitle text data.

A semantic tag adding submodule is configured to add the semantic tags to the corresponding video frames.

A candidate video frame set generation submodule is configured to use video frames having the same semantic tag as a candidate video frame set.

A candidate of video segment data generation submodule is configured to generate the candidate video segment data based on the candidate video frame set.

In one embodiment, the semantic tag extraction submodule includes the following modules.

A candidate semantic tag extraction unit is configured to extract candidates of semantic tags from the subtitle text data according to a preset document theme generation model LDA.

A term frequency-reverse document frequency value calculation unit is configured to calculate term frequency-reverse document frequency values for the candidates of semantic tags.

A semantic tag determining unit is configured to use the top M sorted candidates of semantic tags as the semantic tags, wherein M is a positive integer.

In one embodiment, the video frames further have view text data, and the apparatus further includes the following modules.

A new semantic tag categorization submodule is configured to categorize the semantic tags into new semantic tags with the view text data.

A semantic tag adding submodule is configured to add the new semantic tags to corresponding video frames as semantic tags.

A candidate video frame set generation submodule is configured to use video frames having the same new semantic tag as a candidate video frame set.

In one embodiment, the target video data acquisition module includes the following modules.

A promotion intention data determining submodule is configured to determine current promotion intention data, wherein the promotion intention data comprises intention keywords.

A semantic entity search submodule is configured to locate semantic entities corresponding to the intention keywords in the relationship graph showing the semantic mapping.

A semantic tag determining submodule is configured to determine corresponding semantic tags based on the semantic entities.

A target candidate video segment data screening submodule is configured to screen and select corresponding target candidate video segment data from the candidate video segment data based on the semantic tags.

A target video data integration submodule is configured to integrate the target candidate video segment data into the target video data.

In one embodiment, the target video data integration submodule may include the following modules.

A video segment data sorting unit is configured to sort the target candidate video segment data according to a preset model.

A target video data integration unit is configured to integrate the target video data based on the sorted target candidate video segment data.

In one embodiment, the target video data integration submodule may include the following modules.

A smoothing and de-noising processing unit is configured to perform smoothing and de-noising processing on the target video data, wherein the smoothing and de-noising processing comprises adding a preset warm-up video frame and/or discarding a specified video frame.

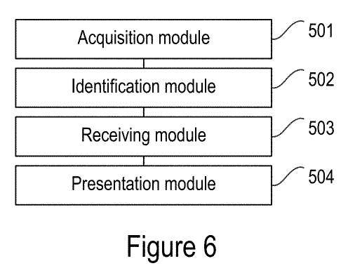

FIG. 6 is a block diagram of an apparatus for identifying video data according to some disclosed embodiments. The apparatus may include the following modules.

An acquisition module 501 is configured to acquire input video data, wherein the input data comprises text data and video data.

An identification module 502 is configured to send the input video data to a server, wherein the server is configured to separately identify the input video data to acquire identification results, and the identification results comprise target video data.

A receiving module 503 is configured to receive the target video data returned by the server.

A presentation module 504 is configured to present the target video data.

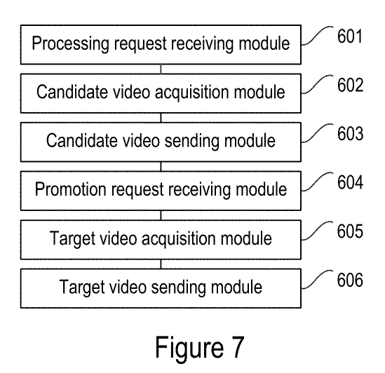

FIG. 7 is a block diagram of a server according to some disclosed embodiments. The server may include the following modules.

A processing request receiving module 601 is configured to receive a processing request submitted from an interactive interface.

A candidate video acquisition module 602 is configured to acquire candidate video segment data according to the processing request.

A candidate video sending module 603 is configured to send the candidate video segment data to the interactive interface.

A promotion request receiving module 604 is configured to receive a promotion request submitted from the interactive interface.

A target video acquisition module 605 is configured to acquire target video data from the candidate video segment data according to the promotion request.

A target video sending module 606 is configured to send the target video data to the interactive interface.

For the device and server embodiments, since they are basically similar to the method embodiments, the description is relatively concise. For the relevant parts, reference may be made to the descriptions in the method embodiments section.

The embodiments in this specification are described in a progressive manner. Each embodiment focuses on the differences one embodiment has from other embodiments; and for the same or similar parts among the embodiments, reference may be made to each other.

Those skilled in the art should understand that the embodiments of the disclosure may be provided as a method, an apparatus, or a computer program product. Therefore, the embodiments of the disclosure may take the form of an entirely hardware embodiment, an entirely software embodiment, or an embodiment combining software and hardware aspects. Moreover, the embodiments of the disclosure may take the form of a computer program product embodied on one or more computer usable storage media (including, but not limited to, a magnetic disk storage, a CD-ROM, and an optical memory) containing computer usable program code.

In a typical configuration, the computer device includes one or more processors (CPUs), input/output interfaces, a network interface, and a memory. The memory may include a computer readable medium in the form of a non-permanent memory, a random-access memory (RAM) and/or a non-volatile memory or the like, such as a read-only memory (ROM) or a Flash memory (Flash RAM). The memory is an example of a computer readable medium. The computer readable medium includes permanent and non-permanent, movable and non-movable media that can achieve information storage by means of any methods or techniques. The information may be computer readable instructions, data structures, modules of programs or other data. Examples of storage media for a computer include, but are not limited to, a phase change memory (PRAM), a static random access memory (SRAM), a dynamic random access memory (DRAM), and other types of random access memories (RAMs), a read-only memory (ROM), an electrically erasable programmable read-only memory (EEPROM), a flash memory, or other memory technologies, a read-only optical disc read-only memory (CD-ROM), a digital versatile disc (DVD), or other optical storages, a magnetic cassette, a magnetic tape or magnetic disk storage, or other magnetic storage devices, or any other non-transmission media that can be used to store information accessible to a computing device. As defined herein, the computer readable media do not include transitory computer readable media such as modulated data signals and carriers.

The disclosed embodiments are described with reference to the flowcharts and/or the block diagrams of the method, the terminal device (system), and the computer program product of the embodiments of the disclosure. It should be understood that each flow and/or block in the flowcharts and/or the block diagrams, and combinations of the flows and/or blocks in the flowcharts and/or the block diagrams, may be implemented with computer program instructions. These computer program instructions may be provided to a processor of a general-purpose computer, a special purpose computer, an embedded processor, or other programmable data processing terminal devices to produce a machine such that the instructions executed by the processor of the computer or other programmable data processing terminal devices produce a device for implementing the functions specified in one or more flows in the flowcharts and/or one or more blocks in the block diagrams.

These computer program instructions may also be stored in a computer readable memory that can direct a computer or other programmable data processing terminal devices to function in a particular manner such that the instructions stored in the computer readable memory produce an article of manufacture including an instruction means that implements the functions specified in one or more flows in the flowcharts and/or one or more blocks in the block diagrams.

These computer program instructions may also be loaded onto a computer or other programmable data processing terminal devices such that a series of operational steps are performed on the computer or other programmable terminal devices to produce computer-implemented processing, so that the instructions executed on the computer or other programmable terminal devices provide steps for implementing the functions specified in one or more flows in the flowcharts and/or one or more blocks in the block diagrams.

Although exemplary embodiments of the disclosure have been described, those skilled in the art can make other changes and modifications to these embodiments once they have learned the basic inventive concept.

Finally, it should also be noted that in this specification, relational terms such as first and second are merely used to distinguish one entity or operation from another entity or operation without necessarily requiring or implying that there is any such actual relationship or order between these entities or operations. It should be noted that the term “include”, “comprise”, or any other variation thereof is intended to encompass a non-exclusive inclusion, so that a process, method, article, or device that includes a series of elements includes not only those elements, but also other elements not explicitly listed, or elements that are inherent to such a process, method, article, or terminal device. The element defined by the statement “including one . . . ”, without further limitation, does not preclude the presence of additional identical elements in the process, method, article, or terminal device that includes the element.

A detailed description of a method for recommending video data and an apparatus for recommending video data provided by the disclosure have been introduced. Specific examples are used herein to describe the principles and implementations of the disclosure. The descriptions of the foregoing embodiments are merely used to help understand the method and core idea of the disclosure. Furthermore, those skilled in the art may make changes to the specific implementations and the application scope according to the idea of the disclosure. Therefore, this description is not to be construed as limiting the application.

What is claimed is:

1. A method comprising:
retrieving, by a server device, text data and video data;
generating, by the server device, a relationship graph, the relationship graph representing a semantic mapping of the text data;
generating, by the server device, candidate video segment data based on the video data, the candidate video segment data comprising semantic tag data;
acquiring, by the server device, target video data according to the relationship graph and the candidate video segment data; and
transmitting, by the server device, the target video data to a client device.

2. The method of claim 1, the retrieving text data comprising:
retrieving, by the server device, speech data; and
converting, by the server device, the speech data to generate the text data.

3. The method of claim 1, the generating a relationship graph comprising:
extracting, by the server device, semantic entities from the text data and using the semantic entities as nodes of the relationship graph; and
extracting, by the server device, associations among the semantic entities and using the associations as edges of the relationship graph.

4. The method of claim 1, the generating candidate video segment data comprising:
dividing, by the server device, the video data into video frames, each video frame in the video frames associated with subtitle text data;
extracting, by the server device, semantic tags from the subtitle text data;
adding, by the server device, the semantic tags to corresponding video frames;
identifying, by the server device, a subset of video frames as a candidate video frame set, each video frame in the subset of video frames being associated with a same semantic tag; and
generating, by the server device, the candidate video segment data using the candidate video frame set.

5. The method of claim 4, the extracting semantic tags further comprising extracting semantic tags from view text data associated with the video frames, the view text data comprising meanings generated using a picture analysis routine on each of the video frames.

6. The method of claim 5, the identifying a subset of video frames as a candidate video frame set further comprising:
categorizing, by the server device, the semantic tags into new semantic tags with the view text data;
adding, by the server device, the new semantic tags to corresponding video frames as semantic tags; and
using, by the server device, video frames having the same new semantic tag as a candidate video frame set.

7. The method of claim 4, the extracting semantic tags further comprising:
extracting, by the server device, candidates of semantic tags from the subtitle text data according to a preset document theme generation model Latent Dirichlet Allocation (LDA);
calculating, by the server device, term frequency-inverse document frequency (TF-IDF) values for the candidates of semantic tags;
sorting, by the server device, the candidates of semantic tags; and
using, by the server device, a top subset of the sorted candidates of semantic tags as the semantic tags.

8. The method of claim 1, the acquiring target video data further comprising:
determining, by the server device, current promotion intention data, the promotion intention data comprising intention keywords;
locating, by the server device, semantic entities corresponding to the intention keywords in the relationship graph;
determining, by the server device, corresponding semantic tags based on the semantic entities;
screening and selecting, by the server device, corresponding target candidate video segment data from the candidate video segment data based on the semantic tags; and
integrating, by the server device, the target candidate video segment data into the target video data.

9. The method of claim 8, the integrating the target candidate video segment data into the target video data further comprising sorting, by the server device, the target candidate video segment data based on a preset model.

10. The method of claim 8, the integrating the target candidate video segment data into the target video data further comprising smoothing and de-noising, by the server device, the target candidate video segment, the smoothing and de-noising comprising adding a preset warm-up video frame and discarding a specified video frame.

11. An apparatus comprising:
a processor; and
a storage medium for tangibly storing thereon program logic for execution by the processor, the stored program logic comprising:
logic, executed by the processor, for retrieving text data and video data,
logic, executed by the processor, for generating a relationship graph, the relationship graph representing a semantic mapping of the text data,
logic, executed by the processor, for generating candidate video segment data based on the video data, the candidate video segment data comprising semantic tag data,
logic, executed by the processor, for acquiring target video data according to the relationship graph and the candidate video segment data, and
logic, executed by the processor, for transmitting the target video data to a client device.

12. The apparatus of claim 11, the logic for retrieving text data comprising:
logic, executed by the processor, for retrieving speech data; and
logic, executed by the processor, for converting the speech data to generate the text data.

13. The apparatus of claim 11, the logic for generating a relationship graph comprising:
logic, executed by the processor, for extracting semantic entities from the text data and using the semantic entities as nodes of the relationship graph; and
logic, executed by the processor, for extracting associations among the semantic entities and using the associations as edges of the relationship graph.

14. The apparatus of claim 11, the logic for generating candidate video segment data comprising:
logic, executed by the processor, for logic, executed by the processor, for dividing the video data into video frames, each video frame in the video frames associated with subtitle text data;
logic, executed by the processor, for extracting semantic tags from the subtitle text data;
logic, executed by the processor, for adding the semantic tags to corresponding video frames;
logic, executed by the processor, for identifying a subset of video frames as a candidate video frame set, each video frame in the subset of video frames being associated with a same semantic tag; and
logic, executed by the processor, for generating the candidate video segment data using the candidate video frame set.

15. The apparatus of claim 14, the logic for extracting semantic tags further comprising logic, executed by the processor, for extracting semantic tags from view text data associated with the video frames, the view text data comprising meanings generated using a picture analysis routine on each of the video frames.

16. The apparatus of claim 15, the logic for identifying a subset of video frames as a candidate video frame set further comprising:
logic, executed by the processor, for categorizing the semantic tags into new semantic tags with the view text data;
logic, executed by the processor, for adding the new semantic tags to corresponding video frames as semantic tags; and
logic, executed by the processor, for using video frames having the same new semantic tag as a candidate video frame set.

17. The apparatus of claim 14, the logic for extracting semantic tags further comprising:
logic, executed by the processor, for extracting candidates of semantic tags from the subtitle text data according to a preset document theme generation model Latent Dirichlet Allocation (LDA);
logic, executed by the processor, for calculating term frequency-inverse document frequency (TF-IDF) values for the candidates of semantic tags;
logic, executed by the processor, for sorting the candidates of semantic tags; and
logic, executed by the processor, for using a top subset of the sorted candidates of semantic tags as the semantic tags.

18. The apparatus of claim 11, the logic for acquiring target video data further comprising:
logic, executed by the processor, for determining current promotion intention data, the promotion intention data comprising intention keywords;
logic, executed by the processor, for locating semantic entities corresponding to the intention keywords in the relationship graph;
logic, executed by the processor, for determining corresponding semantic tags based on the semantic entities;
logic, executed by the processor, for screening and selecting corresponding target candidate video segment data from the candidate video segment data based on the semantic tags; and
logic, executed by the processor, for integrating the target candidate video segment data into the target video data.

19. The apparatus of claim 18, the logic for integrating the target candidate video segment data into the target video data further comprising logic, executed by the processor, for sorting the target candidate video segment data based on a preset model.

20. The apparatus of claim 18, the logic for integrating the target candidate video segment data into the target video data further comprising logic, executed by the processor, for smoothing and de-noising the target candidate video segment, the smoothing and de-noising comprising adding a preset warm-up video frame and discarding a specified video frame.
